(19) United States
(12) Patent Application Publication
(10) Pub. No.: US 2024/0351645 A1
(43) Pub. Date: Oct. 24, 2024

(54) SPOILER DEVICE

(71) Applicant: Honda Motor Co., Ltd., Tokyo (JP)

(72) Inventors: Yuki NAKAMURA, Tokyo (JP); Kei AMBO, Tokyo (JP); Eiji KIMURA, Tokyo (JP); Hiroyuki HAZAWA, Tokyo (JP); Shinichi OZAKI, Tokyo (JP); Satoru KUCHIKI, Saitama (JP); Shogo DEHARA, Tokyo (JP); Shuji NAKA, Tochigi (JP)

(73) Assignee: Honda Motor Co., Ltd., Tokyo (JP)

(21) Appl. No.: 18/608,968

(22) Filed: Mar. 19, 2024

(30) Foreign Application Priority Data
Apr. 24, 2023 (CN) 202310445634.7

(51) Int. Cl. B62D 35/00

(52) U.S. Cl. CPC B62D 35/007

(57) ABSTRACT

A spoiler device is adapted to be installed on a rear edge of a vehicle body component arranged on a vehicle and includes a spoiler body having an upper surface portion and a bent portion bent downward from a rear end of the upper surface portion and a movable mechanism connected to the spoiler body to drive the spoiler body to move relative to the vehicle body component. The spoiler body is movable between a storing position where a front end of the upper surface portion is close to an upper surface of the vehicle body component and an extending position where the upper surface portion extends rearward relative to the vehicle body component via the movable mechanism. Taking an imaginary line extending along the upper surface as a reference, the front end in the extending position is located on or further downward than the imaginary line.

### CROSS-REFERENCE TO RELATED APPLICATION

This application claims the priority benefit of China application no. CN,202310445634.7, filed on Apr. 24, 2023. The entirety of the above-mentioned patent application is hereby incorporated by reference herein and made a part of this specification.

### BACKGROUND

### Technical Field

The disclosure relates to a spoiler device, and in particular, relates to a spoiler device that can be installed on a vehicle.

### Description of Related Art

In recent years, in order to ensure more people can have access to affordable, reliable, sustainable, and advanced energy, research and development to improve fuel efficiency, which contributes to energy efficiency, have been carried out. However, in this technology related to improving fuel efficiency, the aerodynamic performance of the vehicle is an issue.

In the related art (Japanese Patent Publication No. 7157189), a spoiler device is generally arranged at the rear end of the vehicle to improve the aerodynamic performance of the vehicle. Common spoiler devices can be fixed, but there are also technologies that make a spoiler device movable. The spoiler body may move in the vehicle front-rear direction relative to the vehicle body component through a movable mechanism (e.g., linkage) to change its position, so that the aerodynamic performance may be accordingly adjusted. However, in order to further improve the aerodynamic performance, it is necessary to improve the movable path of the spoiler body.

In order to solve the abovementioned problems, the disclosure aims to improve the aerodynamic performance, thereby contributing to energy efficiency.

### SUMMARY

The disclosure provides a spoiler device capable of improving aerodynamic performance.

The disclosure provides a spoiler device adapted to be installed on a rear edge of a vehicle body component arranged on a vehicle. The spoiler body includes a spoiler body having an upper surface portion and a bent portion bent downward from a rear end of the upper surface portion and a movable mechanism connected to the spoiler body to drive the spoiler body to move relative to the vehicle body component. The spoiler body is movable between a storing position where a front end of the upper surface portion is close to an upper surface of the vehicle body component and an extending position where the upper surface portion extends rearward relative to the vehicle body component via the movable mechanism. Taking an imaginary line extending along the upper surface of the vehicle body component as a reference, the front end of the upper surface portion in the extending position is located on the imaginary line or located further downward than the imaginary line, and the upper surface portion intersects the imaginary line. Further, the bent portion in the extending position is located further rearward than the bent portion in the storing position.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a spoiler device applied on a vehicle according to an embodiment of the disclosure.

FIG. 2A and FIG. 2B are schematic views of an appearance of the spoiler device shown in FIG. 1 respectively in a storing position and an extending position.

FIG. 3A and FIG. 3B are schematic side views of the appearance of the spoiler device shown in FIG. 1 respectively in the storing position and the extending position.

FIG. 4A to FIG. 4D are schematic views of movement of the spoiler device shown in FIG. 1 from the storing position to the extending position.

### DESCRIPTION OF THE EMBODIMENTS

The disclosure provides a spoiler device capable of improving aerodynamic performance.

The disclosure provides a spoiler device adapted to be installed on a rear edge of a vehicle body component arranged on a vehicle. The spoiler body includes a spoiler body having an upper surface portion and a bent portion bent downward from a rear end of the upper surface portion and a movable mechanism connected to the spoiler body to drive the spoiler body to move relative to the vehicle body component. The spoiler body is movable between a storing position where a front end of the upper surface portion is close to an upper surface of the vehicle body component and an extending position where the upper surface portion extends rearward relative to the vehicle body component via the movable mechanism. Taking an imaginary line extending along the upper surface of the vehicle body component as a reference, the front end of the upper surface portion in the extending position is located on the imaginary line or located further downward than the imaginary line, and the upper surface portion intersects the imaginary line. Further, the bent portion in the extending position is located further rearward than the bent portion in the storing position.

In an embodiment of the disclosure, the upper surface of the vehicle body component is inclined rearward and downward, and the upper surface portion in the storing position is inclined rearward and downward along the imaginary line.

In an embodiment of the disclosure, the bent portion in the extending position is at a same height as the bent portion in the storing position or is located further upward than the bent portion in the storing position.

In an embodiment of the disclosure, the spoiler device and the vehicle body component are provided on an opening and closing body that can be opened and closed relative to the vehicle body of the vehicle.

To sum up, in the spoiler device provided by the disclosure, the spoiler body is movable between the storing position where the front end of the upper surface portion is close to the upper surface of the vehicle body component and the extending position where the upper surface portion extends rearward relative to the vehicle body component via the movable mechanism. Herein, taking the imaginary line extending along the upper surface of the vehicle body component as the reference, the front end of the upper surface portion in the extending position is located on the imaginary line or located further downward than the imaginary line, and the upper surface portion intersects the imaginary line. Further, the bent portion in the extending position is located further rearward than the bent portion in the storing position. In this way, the spoiler body can extend via the movable mechanism to a position where the front end maintains the same height or is lowered and the rear end moves rearward. In this way, the direction of the airflow flowing above the spoiler body is improved. In particular, the spoiler body in the extending position does not block the airflow flowing rearward along the upper surface of the vehicle body component and can move the separation point where the airflow separates from the vehicle further rearward, so that air resistance is lowered. Accordingly, the aerodynamic performance of the spoiler device provided by the disclosure can be further improved.

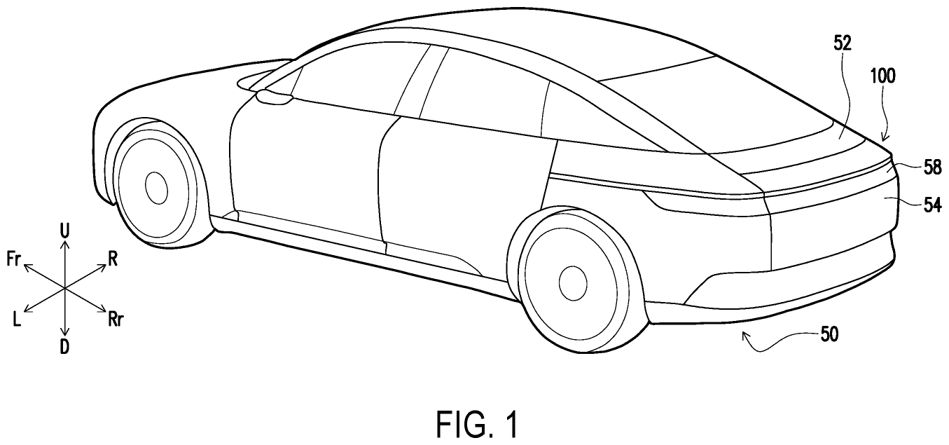

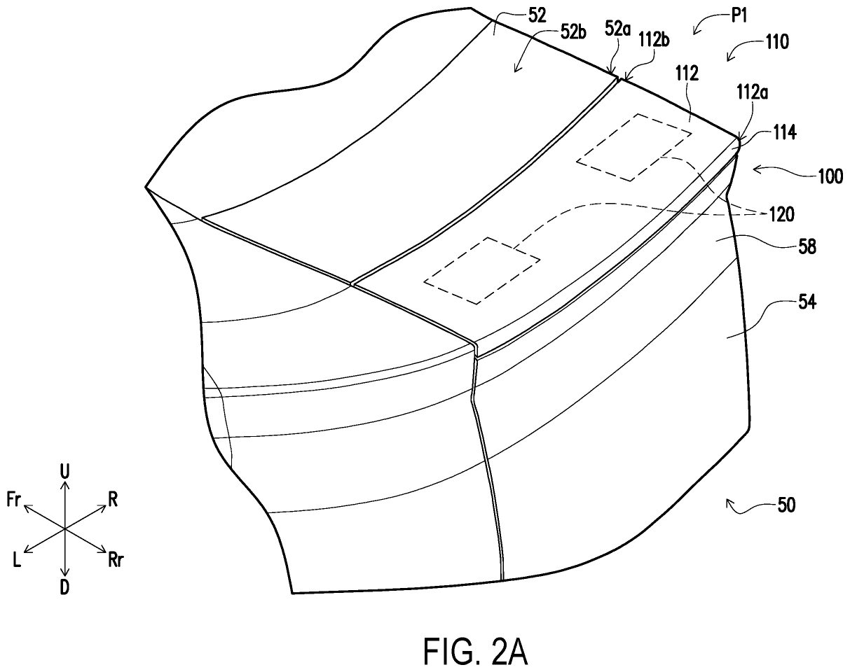

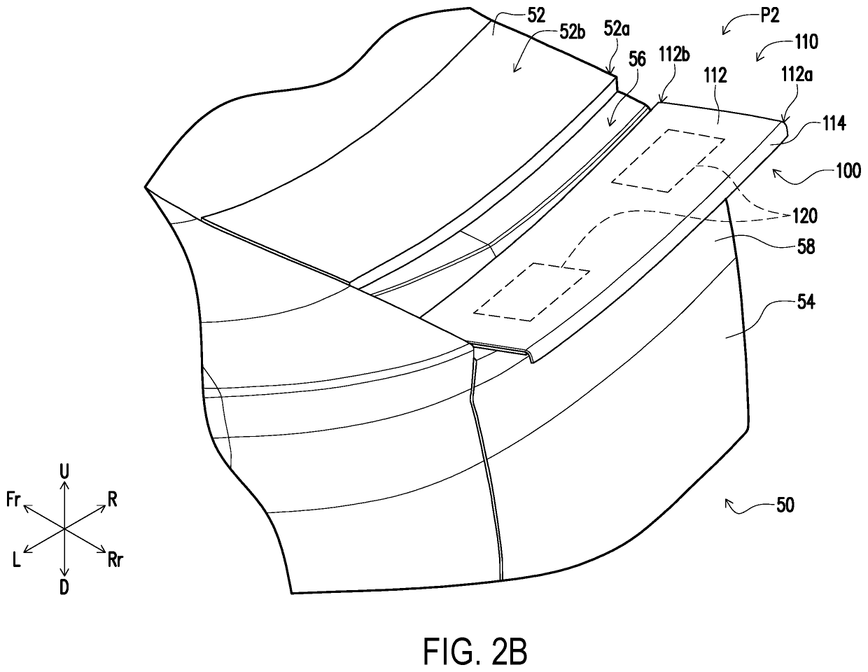

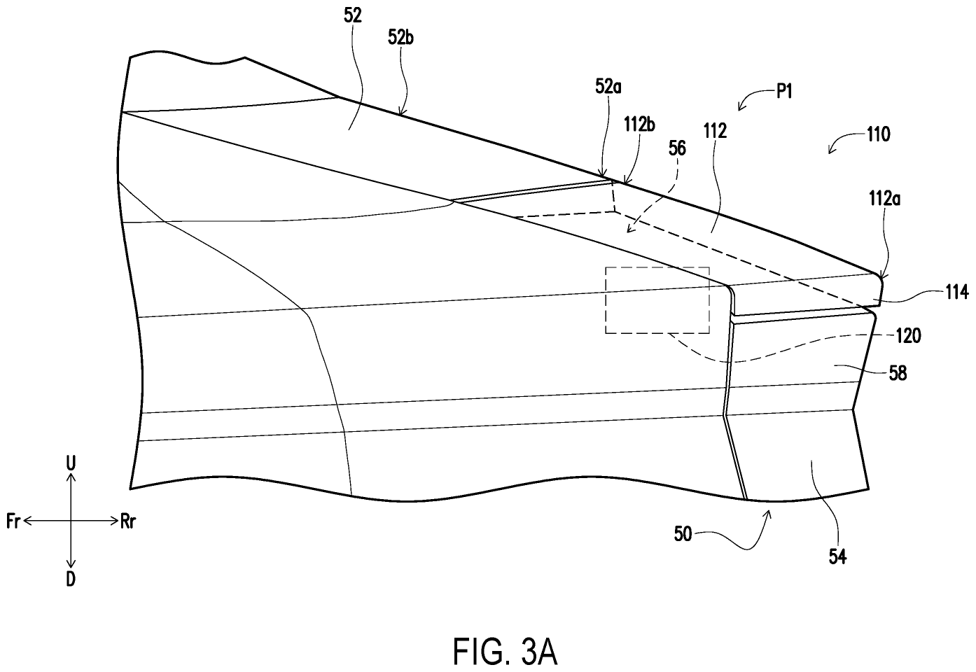

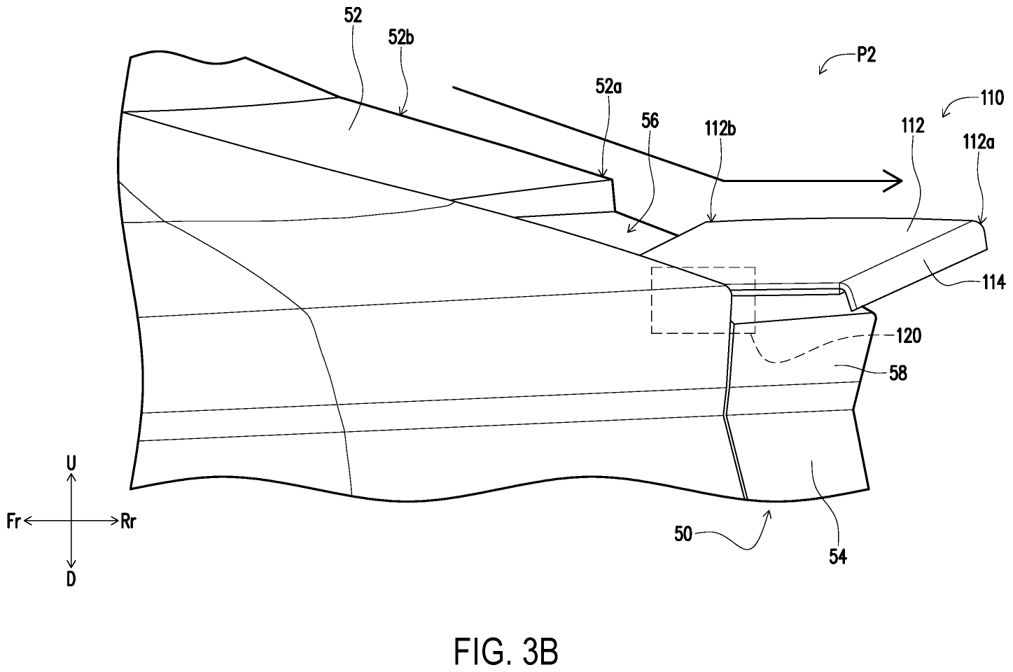

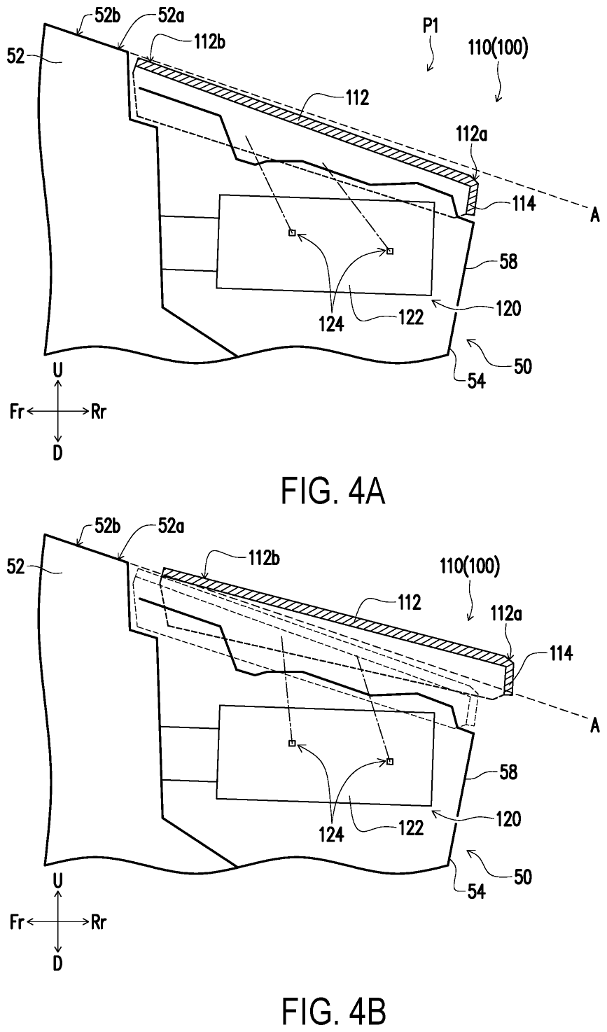

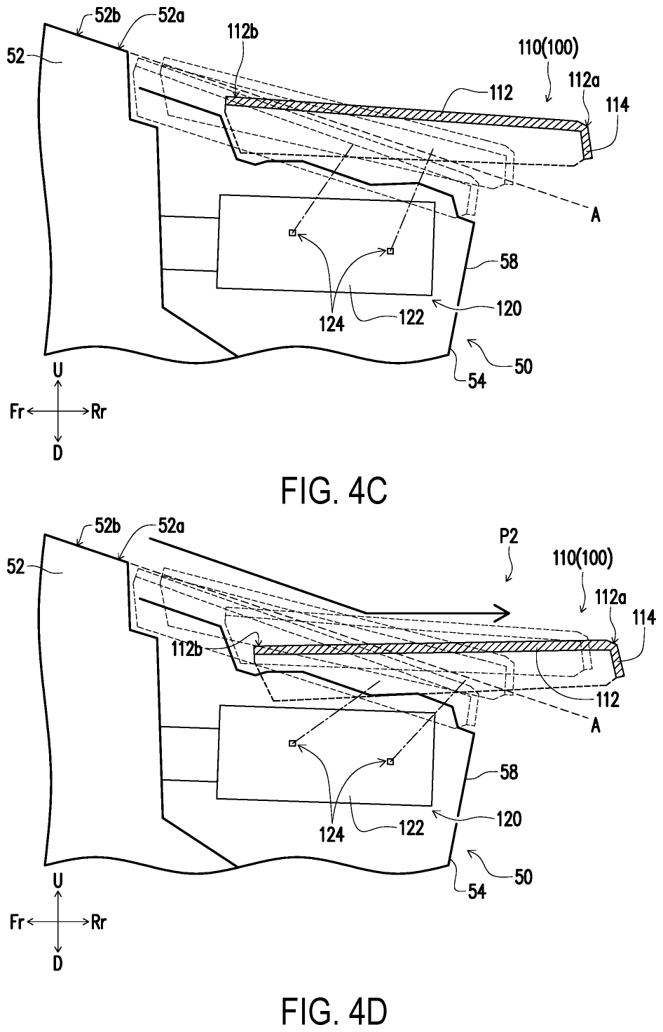

Descriptions of the disclosure are given with reference to the exemplary embodiments illustrated by the accompanying drawings. Herein, FIG. 1 is a schematic view of a spoiler device applied on a vehicle according to an embodiment of the disclosure. FIG. 2A and FIG. 2B are schematic views of an appearance of the spoiler device shown in FIG. 1 respectively in a storing position and an extending position. FIG. 3A and FIG. 3B are schematic side views of the appearance of the spoiler device shown in FIG. 1 respectively in the storing position and the extending position. FIG. 4A to FIG. 4D are schematic views of movement of the spoiler device shown in FIG. 1 from the storing position to the extending position. The applications and the specific structure of a spoiler device 100 provided by this embodiment are to be described in the following paragraphs together with FIG. 1 to FIG. 4D. Herein, in the following paragraphs, a vehicle front-rear direction refers to, for example, a vehicle front direction Fr and a vehicle rear direction Rr in the drawings, a vehicle width direction refers to, for example, a vehicle left direction L and a vehicle right direction R in the drawing, and a vehicle up-down direction refers to, for example, a vehicle up direction U and a vehicle down direction D in the drawings. However, this is only one example of the disclosure, and the disclosure is not limited thereto.

With reference to FIG. 1, in this embodiment, the spoiler device 100 is adapted to be provided at a rear end of a vehicle 50 (shown in FIG. 1) as an exterior component to stabilize airflow passing through the vehicle 50, so as to improving aerodynamic performance. Herein, the movable spoiler device 100 is, for example, an elongated structure that spans left and right sides (e.g., the vehicle left direction L and the vehicle right direction R in FIG. 1) of the vehicle 50 in the vehicle width direction and is adapted to be installed on a rear edge 52a (i.e., an edge corresponding to the vehicle rear direction Rr) of a vehicle body component 52 arranged on the vehicle 50. The vehicle body component 52 is, for example, a roof, window glass, or a hatchback tailgate of the vehicle 50, and the spoiler device 100 is installed on the rear edge 52a of such a vehicle body component 52. However, in other embodiments that are not shown, the spoiler device 100 may also be installed in other parts of the vehicle 50 as required. The application of the spoiler device 100 on the vehicle 50 is not limited in the disclosure (that is, a type of the vehicle body component 52, an installation range of the spoiler device 100 on the vehicle 50, etc. are not limited) and can be adjusted according to needs.

To be specific, in this embodiment, as shown in FIG. 1 to FIG. 3B, the spoiler device 100 includes a spoiler body 110 and a movable mechanism 120. The spoiler body 110 has an upper surface portion 112 and a bent portion 114. The upper surface portion 112 has a rear end 112a (i.e., an end portion corresponding to the vehicle rear direction Rr) and a front end 112b (i.e., an end portion corresponding to the vehicle front direction Fr). The bent portion 114 is bent downward (i.e., the vehicle downward direction D) from the rear end 112a of the upper surface portion 112. The movable mechanism 120 is connected to the spoiler body 110 to drive the spoiler body 110 to move relative to the vehicle body component 52. Herein, the spoiler body 110 is movable between a storing position P1 (as shown in FIG. 2A and FIG. 3A) where a front end 112b of the upper surface portion 112 is close to an upper surface 52b of the vehicle body component 52 and an extending position P2 (as shown in FIG. 2B and FIG. 3B) where the upper surface portion 112 extends rearward (i.e., the vehicle rear direction Rr) relative to the vehicle body component 52 via the movable mechanism 120. In this way, the spoiler body 110 may move between the storing position P1 and the extending position P2 relative to the vehicle body component 52 via the movable mechanism 120. Further, the spoiler body 110 in the extending position P2 may change the aerodynamic performance of the vehicle 50 around the spoiler device 100 (i.e., the rear end of the vehicle 50).

Further, in this embodiment, as shown in FIG. 2A to FIG. 3B, the spoiler body 110 is, for example, an elongated structure that spans the left and right sides (e.g., the vehicle left direction L and the vehicle right direction R in FIG. 1) of the vehicle 50 in the vehicle width direction. Herein, the upper surface portion 112 of the spoiler body 110 is arranged on the rear edge 52a of the vehicle body component 52 and has a plate-like structure when viewed from the side. The bent portion 114 is configured as a protruding structure extending downward from the rear end 112a of the upper surface portion 112. In this way, the spoiler body 110 may be made of a single plate member to form the upper surface portion 112 and be bent at its rear end to form the bent portion 114. However, the spoiler body 110 may also be a composite plate formed by a plurality of plates, and the specific structure and manufacturing method of the spoiler body 110 are not particularly limited in the disclosure.

Further, in this embodiment, the movable mechanism 120 is formed by, for example, a driving source 122 and a linkage mechanism 124 that moves when being driven by the driving source 122. The driving source 122 is installed in the vehicle body 54. One end of the linkage mechanism 124 is connected to the driving source 122 and thereby is connected to a fixed structure such as the vehicle body component 52 or the vehicle body 54 near the vehicle body component 52. The other end of the linkage mechanism 124 is connected to an inner side surface of the spoiler body 110 (detailed connection method for connecting the spoiler body 110 is omitted in FIG. 4A to FIG. 4D). Further, a plurality of movable mechanisms 120 may be provided on the inner side surface of the spoiler body 110 in the vehicle width direction (for example, FIG. 2A to FIG. 3B illustrate a pair of left and right movable mechanisms 120). In this way, the movable mechanisms 120 may drive the spoiler body 110 to move relative to the vehicle body component 52 through the movement of the linkage mechanism 124, for example, to move between the storing position P1 and the extending position P2. However, the specific composition of the movable mechanisms 120 (it can be a single linkage or a relatively rotatable multi-linkages) is not limited in the disclosure, and a driving mechanism other than the driving source 122 and the linkage mechanism 124 may also be used as the movable mechanism 120. As long as the movable mechanism 120 may drive the spoiler body 110 to move between the storing position P1 and the extending position P2 relative to the vehicle body component 52, the specific structure, quantity, and arrangement location of the movable mechanism 120 are not limited in the disclosure and may also be adjusted according to needs.

Therefore, in this embodiment, the storing position P1 refers to, for example, the position where the front end 112b of the upper surface portion 112 of the spoiler body 110 is close to the upper surface 52b of the vehicle body component 52 (as shown in FIG. 2A and FIG. 3A). As such, the spoiler body 110 covers a recess portion space 56 between the rear edge 52a of the vehicle body component 52 and the vehicle body 54 to form a storage state (as shown in FIG. 2A and FIG. 3A). Correspondingly, the extending position P2 refers to, for example, a position where the upper surface portion 112 of the spoiler body 110 extends rearward relative to the vehicle body component 52 via the movable mechanism 120, so that the front end 112b is away from the upper surface 52b of the vehicle body component 52 (as shown in FIG. 2B and FIG. 3B). Therefore, when the spoiler body 110 moves from the storing position P1 to the extending position P2 relative to the vehicle body component 52 via the movable mechanism 120, it is preferable that the upper surface portion 112 of the spoiler body 110 moves rearward away from the vehicle body component 52. As such, the spoiler body 110 in the extending position P2 may change the aerodynamic performance of the vehicle 50 around the spoiler device 100 (i.e., the rear end of the vehicle 50).

As an example, in the spoiler device 100 of this embodiment, the spoiler body 110 may move from the storing position P1 to the extending position P2 as shown in FIG. 4A to FIG. 4D. When the spoiler body 110 is in the storing position P1, as shown in FIG. 4A, the front end 112b of the upper surface portion 112 of the spoiler body 110 is close to the upper surface 52b of the vehicle body component 52. Preferably, the upper surface 52b of the vehicle body component 52 is inclined rearward and downward. Accordingly, the upper surface portion 112 in the storing position P1 is flush with the upper surface 52b of the vehicle body component 52, that is, the upper surface portion 112 in the storing position P1 is also inclined rearward and downward (as shown in FIG. 2A, FIG. 3A, and FIG. 4A). In this way, the spoiler body 110 may be stored in the storing position P1 without damaging the appearance of the vehicle 50 near the vehicle body component 52 and the spoiler device 100, but the disclosure is not limited thereto. Next, the spoiler body 110 may move toward the rear of the vehicle 50 (i.e., the vehicle rear direction Rr) relative to the vehicle body component 52 via the movable mechanism 120 and thereby extends from the storing position P1 toward the extending position P2.

For instance, as shown in FIG. 4B, driven by the movable mechanism 120 (for example, extending of the linkage mechanism that is not shown), the spoiler body 110 is preferably lifted upward relative to the vehicle body component 52 (i.e., the vehicle up direction U) and moves rearward. As shown in FIG. 4C, the front end 112b of the upper surface portion 112 of the spoiler body 110 then moves downward, and the rear end (i.e., bent portion 114) of the spoiler body 110 moves rearward. Finally, when the spoiler body 110 is located in the extending position P2 as shown in FIG. 4D, the front end 112b of the upper surface portion 112 of the spoiler body 110 is away from the upper surface 52b of the vehicle body component 52, and the entire spoiler body 110 moves rearward and extends relative to the vehicle body component 52. Similarly, the spoiler body 110 may also move from the extending position P2 to the storing position P1 relative to the vehicle body component 52 via the movable mechanism 120, as shown in the process of FIG. 4D to FIG. 4A. However, during the intermediate movement of the spoiler body 110 between the storing position P1 and the extending position P2, a state of the spoiler body 110 is not limited in the disclosure and can be adjusted according to needs.

In this embodiment, the spoiler body 110 of the spoiler device 100 has the following configuration. Taking an imaginary line A extending along the upper surface 52b of the vehicle body component 52 as a reference, the front end 112b of the upper surface portion 112 in the extending position P2 (FIG. 4D) is located on the imaginary line A or located further downward than the imaginary line A (In FIG. 4D, the front end 112b of the upper surface portion 112 is shown to be located further downward than the imaginary line A), and the upper surface portion 112 intersects the imaginary line A (as shown in FIG. 4D). Further, the bent portion 114 in the extending position P2 (FIG. 4D) is located further rearward than the bent portion 114 in the storing position P1 (FIG. 4A). That is, the front end 112b of the upper surface portion 112 in the extending position P2 is at a same height as the front end 112b of the upper surface portion 112 in the storing position P1 or is located further downward (i.e., lower) than the front end 112b of the upper surface portion 112 in the storing position P1, and therefore, the upper surface portion 112 intersects the imaginary line A (extends along the upper surface 52b of the vehicle body component 52). Further, the bent portion 114 arranged at the rear end of the spoiler body 110 moves rearward in the extending position P2, so that the spoiler body 110 extends rearward relative to the vehicle body component 52. In this way, the spoiler body 110 may extend via the movable mechanism 120 to a position where the front end (i.e., the front end 112b of the upper surface portion 112) maintains the same height or is lowered and the rear end (i.e., the bent portion 114) moves rearward. In this way, a direction (as shown by the arrow in FIG. 4D) of airflow flowing above the spoiler body 110 is improved. In particular, the spoiler body 110 in the extending position P2 does not block the airflow flowing rearward along the upper surface 52b of the vehicle body component 52 and can move a separation point (i.e., the rear end of the spoiler body 110) where the airflow separates from the vehicle 50 further rearward, so that air resistance is lowered. Accordingly, the aerodynamic performance of the spoiler device 100 may be further improved.

Further, as shown in FIG. 2A, FIG. 3A, and FIG. 4A, in this embodiment, preferably, the upper surface 52b of the vehicle body component 52 is inclined rearward and downward. Further, the upper surface portion 112 in the storing position P1 is inclined rearward and downward along the imaginary line A (that is, upper surface portion 112 in the storing position P1 is flush with the upper surface 52b of the vehicle body component 52 inclined rearward and downward). In this way, when the spoiler body 110 moves rearward to the extending position P2, even if the front end 112b of the upper surface portion 112 in the extending position P2 is located on the inclined imaginary line A, the front end 112b of the upper surface portion 112 in the extending position P2 (FIG. 4D) is also located further downward (i.e., lower) than the upper surface portion 112 in the storing position P1 (FIG. 4A). If the front end 112b of the upper surface portion 112 in the extending position P2 is located on a position further downward than the inclined imaginary line A, the front end 112b of the upper surface portion 112 in the extending position P2 is lowered to a position further downward than the upper surface portion 112 in the storing position P1.

It thus can be seen that when the spoiler body 110 moves from the storing position P1 to the extending position P2, it is preferable that the front end 112b of the upper surface portion 112 after movement is located at a position lower than the front end 112b of the upper surface portion 112 before movement. In this way, the spoiler body 110 may extend via the movable mechanism 120 to a position where the front end (i.e., the front end 112b of the upper surface portion 112) is lowered and the rear end (i.e., the bent portion 114) moves rearward. In this way, the direction of the airflow flowing above the spoiler body 110 is improved. However, in other embodiments that are not shown, if the upper surface 52b of the vehicle body component 52 extends rearward and horizontally, when the spoiler body 110 moves from the storing position P1 to the extending position P2, the front end 112b of the upper surface portion 112 after movement may be at the same height (on the imaginary line A) as the front end 112b of the upper surface portion 112 before movement or may be located further downward (i.e., lower) than the front end 112b of the upper surface portion 112 before movement. As long as the front end 112b of the upper surface portion 112 maintains its height or is lowered after the spoiler body 110 moves to the extending position P2, the specific structure of the vehicle body component 52, the relative relationship between the storing position P1 and the extending position P2 (before and after the spoiler body 110 moves), and so on, are not limited in the disclosure and can be adjusted according to needs.

Further, in this embodiment, preferably, the bent portion 114 in the extending position P2 (FIG. 4D) is located at the same height as the bent portion 114 in the storing position P1 (FIG. 4A) or at a position further upward than the bent portion 114 in the storing position P1 (FIG. 4D shows that the bent portion 114 in the extending position P2 is further upward than the bent portion 114 in the storing position P1). That is, when the spoiler body 110 moves from the storing position P1 to the extending position P2, it is preferable that the bent portion 114 of the spoiler body 110 moves rearward and maintains the same height or is lifted upward. Therefore, the bent portion 114 after movement is located at the same height as the bent portion 114 before movement or at a position further upward than the bent portion 114 before movement. In this way, compared to the situation where the bent portion 114 moves rearward and lowers downward, the bent portion 114 after movement maintains the height or is lifted upward compared to the bent portion 114 before movement. In this way, the spoiler body 110 may be prevented from covering other components (e.g., vehicle lights) located at the rear end of the vehicle 50. However, as long as the bent portion 114 at the rear end moves backward after the spoiler body 110 moves to the extending position P2, the disclosure is not limited to this, and adjustment can be made according to needs.

In addition, in this embodiment, as shown in FIG. 2A to FIG. 3B, the spoiler device 100 and the vehicle body component 52 are arranged on an opening and closing body 58 (e.g., trunk, etc.) that can be opened and closed relative to the vehicle body 54 of the vehicle 50. For instance, the recess portion space 56 is formed between the vehicle body component 52 (e.g., hatchback tailgate) and other parts of the vehicle body 54 (e.g., rear bumper, etc.), and the recess portion space 56 communicates with the outside. As such, the vehicle body component 52, the recess portion space 56, and part of the vehicle body 54 form the opening and closing body 58 such as a trunk that can be opened and closed relative to the vehicle body 54. The spoiler device 100 and the vehicle body component 52 are arranged on the opening and closing body 58 so as to cover the recess portion space 56 and can be opened and closed relative to the recess portion space 56 (for example, the vehicle body component 52 acting as a door of the opening and closing body 58 moves relative to the vehicle body 54 to open and close the recess portion space 56). Therefore, the vehicle body component 52 and the spoiler device 100 installed on the rear edge 52a of the vehicle body component 52 may move relative to the vehicle body 54 as the opening and closing body 58 is opened and closed. Preferably, when the opening and closing body 58 is opened and closed (for example, the operation of the vehicle 50 stops, the opening and closing body 58 is opened, and luggage is placed in the recess portion space 56, etc.), the spoiler device 100 is located in the storing position P1 and moves together with the vehicle body component 52 acting as the door of the opening and closing body 58. However, the disclosure is not limited thereto. Further, the spoiler device 100 has the following configuration. When the vehicle body component 52 acting as the door of the opening and closing body 58 is closed (not moved relative to the vehicle body 54), the spoiler body 110 in the storing position P1 is located on the recess portion space 56 to cover the recess portion space 56 (as shown in FIG. 2A and FIG. 3A), so that the spoiler device 100 and the vehicle body component 52 close the opening and closing body 58 of the vehicle 50. Correspondingly, the spoiler body 110 in the extending position P2 moves to the rear of the recess portion space 56 to expose the recess portion space 56 (as shown in FIG. 2B and FIG. 3B), so that the spoiler device 100 and the vehicle body component 52 open the opening and closing body 58 of the vehicle 50. In this way, the area between the spoiler device 100 and the vehicle body component 52 may be effectively utilized. However, the disclosure is not limited thereto, and adjustment can be made according to needs.

In view of the foregoing, in the spoiler device provided by the disclosure, the spoiler body is movable between the storing position where the front end of the upper surface portion is close to the upper surface of the vehicle body component and the extending position where the upper surface portion extends rearward relative to the vehicle body component via the movable mechanism. Herein, taking the imaginary line extending along the upper surface of the vehicle body component as the reference, the front end of the upper surface portion in the extending position is located on the imaginary line or located further downward than the imaginary line, and the upper surface portion intersects the imaginary line. Further, the bent portion in the extending position is located further rearward than the bent portion in the storing position. Preferably, the upper surface portion in the storing position is inclined rearward and downward along the imaginary line. Further, the bent portion in the extending position is at the same height as the bent portion in the storing position or is located further upward than the bent portion in the storing position. In this way, the spoiler body may extend via the movable mechanism to a position where the front end maintains the same height or is lowered and the rear end moves rearward. In this way, the direction of the airflow flowing above the spoiler body is improved. In particular, the spoiler body in the extending position does not block the airflow flowing rearward along the upper surface of the vehicle body component and can move the separation point where the airflow separates from the vehicle further rearward, so that air resistance is lowered. Accordingly, the aerodynamic performance of the spoiler device provided by the disclosure may be further improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A spoiler device, adapted to be installed on a rear edge of a vehicle body component arranged on a vehicle, comprising:
a spoiler body having an upper surface portion and a bent portion bent downward from a rear end of the upper surface portion; and
a movable mechanism connected to the spoiler body to drive the spoiler body to move relative to the vehicle body component, wherein
the spoiler body is movable between a storing position where a front end of the upper surface portion is close to an upper surface of the vehicle body component and an extending position where the upper surface portion extends rearward relative to the vehicle body component via the movable mechanism,
taking an imaginary line extending along the upper surface of the vehicle body component as a reference, the front end of the upper surface portion in the extending position is located on the imaginary line or located further downward than the imaginary line, and the upper surface portion intersects the imaginary line, and
the bent portion in the extending position is located further rearward than the bent portion in the storing position.

2. The spoiler device according to claim 1, wherein
the upper surface of the vehicle body component is inclined rearward and downward, and the upper surface portion in the storing position is inclined rearward and downward along the imaginary line.

3. The spoiler device according to claim 1, wherein
the bent portion in the extending position is at a same height as the bent portion in the storing position or is located further upward than the bent portion in the storing position.

4. The spoiler device according to claim 2, wherein
the bent portion in the extending position is at a same height as the bent portion in the storing position or is located further upward than the bent portion in the storing position.

5. The spoiler device according to claim 1, wherein
the spoiler device and the vehicle body component are provided on an opening and closing body that can be opened and closed relative to the vehicle body of the vehicle.

6. The spoiler device according to claim 2, wherein
the spoiler device and the vehicle body component are provided on an opening and closing body that can be opened and closed relative to the vehicle body of the vehicle.
